(19) United States
(12) Patent Application Publication
(10) Pub. No.: US 2010/0220057 A1
(43) Pub. Date: Sep. 2, 2010

(54) FINGER OPERATED COMPUTER MOUSE

(76) Inventor: Mark D. Carder, Birmingham, AL (US)

Correspondence Address: BUSH INTELLECTUAL PROPERTY LAW;c/o CPA Global, P.O. Box 52050, Minneapolis, MN, 55402, US

(21) Appl. No.: 12/394,436

(22) Filed: Feb. 27, 2009

(51) Int. Cl. G06F 3/033

(52) U.S. Cl. 345/163

(57) ABSTRACT

A finger operated computer mouse comprising a housing, a sensor located within the housing for sensing movement of the computer mouse, and a transmitter located within the housing for communicating data from the computer mouse to a remote computer. The top of the housing comprises a recessed portion for receiving a finger tip of a user and a channel connecting the recessed portion to a proximal end of the housing. The recessed portion and the channel preferably have converging sidewalls for engaging opposing sides of the user's finger. The recessed portion comprises a primary push button such that the computer mouse is operable to transmit data to the computer when the primary push button is pressed. The computer mouse is capable of supporting the end of only one finger of the user.

### FIELD OF THE INVENTION

The present invention relates to computer peripheral devices, and more particularly, to a finger operated computer mouse.

### BACKGROUND OF THE INVENTION

A typical computer mouse is designed to support a user's hand, which rests on top of the mouse. The index and middle fingers operate one or more push buttons that transmit various information to a remote computer in proximity to the computer mouse. The computer mouse can be moved around on a substantially planar surface, such as a desktop or mouse pad, which controls the location of a cursor on the computer display screen. Communication between the computer mouse and the computer can be via wired or wireless methods, as is well known in the art. In addition, sensing the movement of the computer mouse relative to the planar surface and translating this movement to cursor movement on the computer display screen is also well known in the art. Examples of prior art teaching various computer peripheral technologies include U.S. Pat. No. 5,854,621 to Junod, U.S. Pat. No. 5,912,661 to Siddiqui, U.S. Pat. No. 6,801,967 to Nakamura, U.S. Pat. No. 7,420,541 to Lee, and US Patent Publication No. 20070040801 to Chung, the disclosures of which are incorporated herein by reference.

One problem with prior art hand controlled computer mice is that moving the typical mouse frequently requires wrist and whole arm movement, which may lead to repetitive strain injuries such as carpal tunnel syndrome. Accordingly, what is needed, and is not found in the prior art, is a computer mouse that is primarily operated by a single finger.

### SUMMARY OF THE INVENTION

The present invention is a finger operated computer mouse comprising a housing, a sensor located within the housing for sensing movement of the computer mouse relative to a substantially planar surface in contact with the bottom of the housing, and a transmitter located within the housing for communicating data from the computer mouse to a remote computer. The top of the housing comprises a recessed portion for receiving a finger tip of a user and a channel connecting the recessed portion to a proximal end of the housing. The recessed portion and the channel preferably have converging planar sidewalls for engaging opposing sides of the user's finger. The recessed portion comprises a primary push button such that the computer mouse is operable to transmit data to the computer when the primary push button is pressed or “clicked”. Each of the opposing sides of the housing preferably comprises a secondary push button such that the computer mouse is operable to transmit data to the computer when either secondary push button is pressed. The distal end of the housing preferably comprises a rotatable scroll wheel such that the computer mouse is operable to transmit data to the computer when the wheel is rotated. The computer mouse is capable of supporting the end of only one finger of the user such that the remaining fingers on the same hand of the user may be supported directly on the substantially planar surface.

These and other features of the invention will become apparent from the following detailed description of the preferred embodiments of the invention.

### BRIEF DESCRIPTION OF THE DRAWINGS

FIG. 1 is a perspective view of the finger operated computer mouse of the present invention.

FIG. 2 is a distal end view of the finger operated computer mouse.

FIG. 3 is a side view of the finger operated computer mouse.

FIG. 4 is a bottom view of the finger operated computer mouse.

FIG. 5 is a perspective view of the finger operated computer mouse having a user's finger resting thereon.

### DETAILED DESCRIPTION OF THE PREFERRED EMBODIMENTS

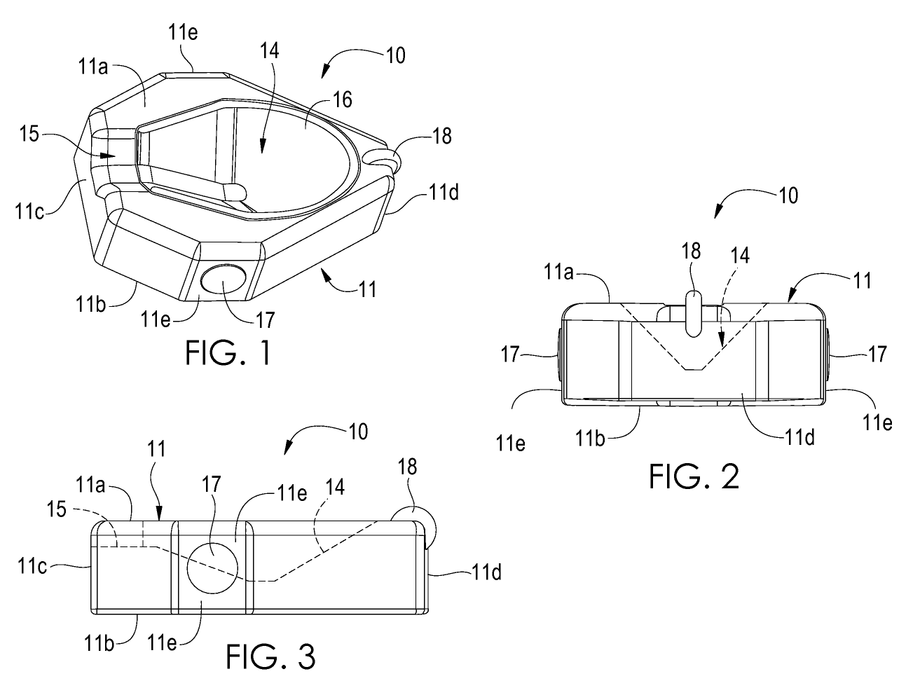

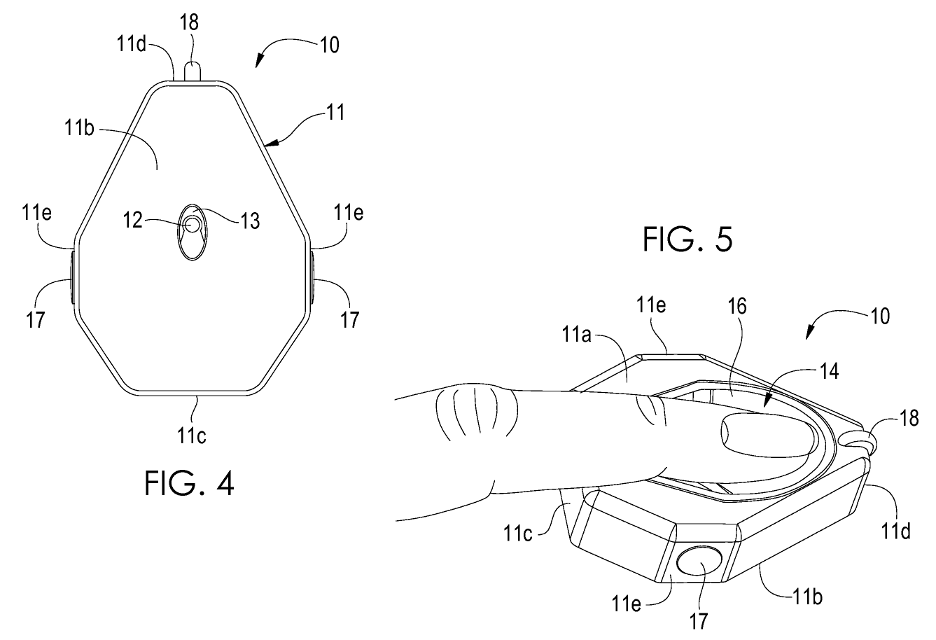

The preferred embodiments of the present invention are illustrated in FIGS. 1-5 and further described hereinbelow, wherein the invention is a finger operated computer mouse 10 comprising a housing 11 having a top 11a, a bottom 11b, a proximal end 11c, a distal end 11d, and opposing sides 11e. The internal components of the computer mouse 10 include typical mouse components, such as a sensor mechanism for sensing movement of the computer mouse 10 relative to a substantially planar surface in contact with the bottom 11b of the housing 11, and a transmitter for communicating data from the computer mouse 10 to a remote computer. The sensor mechanism 12 of the computer mouse 10 preferably comprises an optical or laser sensor that senses the planar surface through an opening or window 13 in the bottom 11b of the housing 11. The computer mouse 10 preferably communicates with the computer via wireless technology, as is known in the art.

The top 11a of the housing 11 comprises a recessed portion 14 for receiving a finger tip of a user and a channel 15 connecting the recessed portion 14 to the proximal end 11c of the housing 11. The recessed portion 14 and the channel 15 preferably have converging planar sidewalls for engaging opposing sides of the user's finger. This feature allows the computer mouse 10 to accommodate fingers of various sizes. The recessed portion 14 comprises a primary push button 16 such that the computer mouse 10 is operable to transmit data to the computer when the primary push button 16 is pressed or “clicked”. It is preferable that the perimeter of the primary push button 16 substantially coincides with the perimeter of the recessed portion 14, best shown in FIG. 1. Each of the opposing sides 11e of the housing 11 preferably comprises a secondary push button 17 such that the computer mouse 10 is operable to transmit data to the computer when either secondary push button 17 is pressed. The distal end 11d of the housing 11 preferably comprises a rotatable scroll wheel 18 such that the computer mouse 10 is operable to transmit data to the computer when the wheel 18 is rotated. The operation of mouse push buttons and scroll wheels is well known in the art.

The computer mouse 10 is capable of supporting the end of only one finger of the user such that the remaining fingers on the same hand of the user may be supported directly on the substantially planar surface or suspended thereabove.

In use, the end of a user's finger, preferably the index finger, is placed on the computer mouse 10, wherein the tip of the finger rests in the recessed portion 14 and the end of the finger below the tip rests in the channel 15. Movement of the finger easily moves the computer mouse 10, which translates to movement of the cursor on the computer display screen. The index finger can be used to press the primary push button 16 and to operate the scroll wheel 18. The secondary push buttons 17, if present, can be easily operated by either the thumb or middle finger.

While the invention has been shown and described in some detail with reference to specific exemplary embodiments, there is no intention that the invention be limited to such detail. On the contrary, the invention is intended to include any alternative or equivalent embodiments that fall within the spirit and scope of the invention as described above and as recited in the appended claims.

1. A finger operated computer mouse, comprising:
a. a housing having a top, a bottom, a proximal end, a distal end, and opposing sides;
b. a sensor located within said housing for sensing movement of said bottom of said housing relative to a substantially planar surface in contact with said bottom of said housing; and
c. a transmitter located within said housing for communicating data from said computer mouse to a remote computer;
d. wherein said top of said housing comprises a recessed portion for receiving a finger tip of a user and a channel connecting said recessed portion to said proximal end of said housing, wherein said recessed portion and said channel have converging planar sidewalls for engaging opposing sides of the user's finger, wherein said recessed portion comprises a primary push button and said computer mouse is operable to transmit data to the computer when said primary push button is pressed;
e. wherein each of said opposing sides of said housing comprises a secondary push button, wherein said computer mouse is operable to transmit data to the computer when said secondary push button is pressed;
f. wherein said distal end of said housing comprises a rotatable wheel, wherein said computer mouse is operable to transmit data to the computer when said wheel is rotated; and
g. wherein said computer mouse is capable of supporting the end of only one finger of the user such that the remaining fingers on the same hand of the user are supportable directly on the substantially planar surface.

2. A finger operated computer mouse, comprising:
a. a housing having a top, a bottom, a proximal end, a distal end, and opposing sides;
b. a sensor located within said housing for sensing movement of said bottom of said housing relative to a substantially planar surface in contact with said bottom of said housing; and
c. a transmitter located within said housing for communicating data from said computer mouse to a remote computer;
d. wherein said top of said housing comprises a recessed portion for receiving a finger tip of a user, wherein said recessed portion has converging sidewalls for engaging opposing sides of the user's finger, wherein said recessed portion comprises a primary push button and said computer mouse is operable to transmit data to the computer when said primary push button is pressed; and
e. wherein said computer mouse is capable of supporting the end of only one finger of the user such that the remaining fingers on the same hand of the user are supportable directly on the substantially planar surface.

3. A finger operated computer mouse according to claim 2 wherein said top of said housing further comprises a channel connecting said recessed portion to said proximal end of said housing, wherein said channel has converging sidewalls for engaging opposing sides of the user's finger.

4. A finger operated computer mouse according to claim 2 wherein each of said opposing sides of said housing comprises a secondary push button, wherein said computer mouse is operable to transmit data to the computer when said secondary push button is pressed.

5. A finger operated computer mouse according to claim 2 wherein said distal end of said housing comprises a rotatable wheel, wherein said computer mouse is operable to transmit data to the computer when said wheel is rotated.

6. A finger operated computer mouse, comprising:
a. a housing having a top, a bottom, a proximal end, a distal end, and opposing sides;
b. a sensor located within said housing for sensing movement of said computer mouse relative to a substantially planar surface in contact with said bottom of said housing; and
c. a transmitter located within said housing for communicating data from said computer mouse to a remote computer;
d. wherein said top of said housing comprises a recessed portion for receiving a finger tip of a user, wherein said recessed portion comprises a primary push button and said computer mouse is operable to transmit data to the computer when said primary push button is pressed; and
e. wherein said computer mouse is capable of supporting the end of only one finger of the user.

7. A finger operated computer mouse according to claim 6 wherein said recessed portion has converging sidewalls for engaging opposing sides of the user's finger.

8. A finger operated computer mouse according to claim 6 wherein said top of said housing further comprises a channel connecting said recessed portion to said proximal end of said housing, wherein said channel has converging sidewalls for engaging opposing sides of the user's finger.

9. A finger operated computer mouse according to claim 6 wherein each of said opposing sides of said housing comprises a secondary push button, wherein said computer mouse is operable to transmit data to the computer when said secondary push button is pressed.

10. A finger operated computer mouse according to claim 6 wherein said distal end of said housing comprises a rotatable wheel, wherein said computer mouse is operable to transmit data to the computer when said wheel is rotated.
